(19) United States
(12) Patent Application Publication
(10) Pub. No.: US 2005/0052489 A1
(43) Pub. Date: Mar. 10, 2005

(54) Maintenance method for inkjet printer

(76) Inventors: Tae-kyun Kim, Suwon-city (KR); Kyung-chool Choi, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/802,759

(22) Filed: Mar. 18, 2004

(30) Foreign Application Priority Data
Sep. 6, 2003 (KR) 2003-62391

(51) Int. Cl. B41J 2/165

(52) U.S. Cl. 347/29; 347/33

(57) ABSTRACT

A maintenance method for an inkjet printer, includes the steps of a) wiping a nozzle surface of a print head with a wiper, b) calculating a number (X1) of ink firings and comparing the calculated number (X1) with a first reference value (Y1); c) if X1≧Y1 in step b), blocking the print head; and d) cleaning the rear surface of the print head, with the print head being blocked. While the rear surface of the print head is cleaned, the nozzle portion of the print head is prevented from being contaminated by the ink remaining after the cleaning.

### CROSS-REFERENCE TO RELATED APPLICATIONS

This application claims the benefit under 35 U.S.C. §119(a) of Korean Patent Application No. 2003-62391 filed Sep. 6, 2003, in the Korean Intellectual Property Office, the disclosure of which is incorporated herein by reference in its entirety.

### BACKGROUND

1. Field of the Invention

The present invention relates to a maintenance method of an inkjet printer. More particularly, the present invention relates to a maintenance method of an inkjet printer for cleaning a rear surface of a print head.

2. Description of the Related Art

Inkjet printers are widely used for their advantages such as low cost, easy color representation and low noise. The inkjet printer usually has an ink cartridge holding ink therein, and also a print head having a plurality of nozzles at the ink cartridge.

As the ink is fired through the nozzles of the print head, a desired image is realized. However, as ink is fired through the nozzles, the nozzle surface can easily become contaminated. When this happens, image quality deteriorates. In order to resolve this problem a wiping process in which a carriage carrying the print head thereon is moved to a service region provided at a side of the printer system is performed. After that, a maintenance process in which the print head is capped so as to be protected from the outside is performed.

FIG. 1A shows one example of a conventional maintenance method, and FIG. 1B shows the circle ‘A’ of FIG. 1A in detail.

Referring to FIGS. 1A and 1B, upon completion of printing or after a predetermined time after the printing, the carriage 1 is moved to the service region and maintained. There is a cylinder-type maintenance bar 9 rotatably disposed in the service region. From the outer circumference of the maintenance bar 9, first to third wipers 5, 6, 7 and a capping portion 8 protrude from the outer diameter.

First, the first wiper 5, which is protruded so as to overlap with the print head 3 when the carriage 1 moves to the service region, is moved along a nozzle surface 3a of the print head 3 in accordance with the rotation of the maintenance bar 9, thereby wiping the nozzle surface 3a. Next, a rear surface 3b (FPC surface of print head) of the print head 3 is cleaned by the second wiper 6, and the nozzle surface 3a is re-wiped by the third wiper 7. Finally, the capping portion 8, by the rotation of the maintenance bar 9 is made to cap, and thus protect, the nozzle surface 3a of the print head 3.

One problem is that, because the remaining ink on the rear surface 3b of the print head 3 has a high viscosity, the ink is not removed by the wiping of the second wiper 6, but remains and contaminates the nozzle surface 3a. The remaining ink 15 is of too high viscosity to be wiped by the third wiper 7, causing problems such as image quality deterioration in the printer.

### SUMMARY OF THE INVENTION

In order to overcome the problems described above, and to provide other advantages, it is an aspect of the present invention to provide an inkjet printer maintenance method, which is improved over the conventional maintenance method. According to an embodiment of the present invention, the nozzle surface and the rear surface of the print head are wiped and then capped to provide an improved inkjet printer maintenance method which prevents the nozzle surface of the print head from being re-contaminated by high-viscosity remaining ink on the rear surface.

In order to accomplish the above aspects and other features of the present invention, a maintenance method for an inkjet printer wipes a nozzle surface of a print head with a wiper, blocks the nozzle surface from outside, and cleans the print head excluding the blocked nozzle surface.

The nozzle surface and the rear surface are blocked from each other by capping, or as the wiper is positioned in line with the rear surface of the print head.

The rear surface of the print head is cleaned as the remaining ink is absorbed by an absorption member, and the absorption member performs the cleaning operation while moving along the rear surface of the print head.

Meanwhile, the rear surface of the print head is cleaned as a cleaning arm is moved along the rear surface of the print head.

A maintenance method for an inkjet printer according to another aspect of the present invention includes the steps of a) wiping a nozzle surface of a print head with a wiper, b) calculating a number (X1) of ink droplets firing and comparing the calculated number (X1) with a first reference value (Y1), c) if X1≧Y1 in the step b), blocking the nozzle surface of the print head, and d) cleaning the print head, with the nozzle surface being blocked.

A maintenance method for an inkjet printer according to yet another aspect of the present invention includes the steps of: a) wiping a nozzle surface of a print head with a wiper, b) calculating a number (X2) of wiping on the print head and comparing the calculated number (X2) with a second reference value (Y2), c) if X2≧Y2 in the step b), blocking the nozzle surface of the print head, and d) cleaning the print head, with the nozzle surface being blocked.

The step b) further comprises the step of calculating an amount (X3) of fired ink droplets and comparing the calculated amount (X3) with a third reference value (Y3), and the step c) blocks the print head if the conditions of X1<Y1 and X3≧Y3 are met.

In the step c), the print head is capped, or the wiper is positioned in line with the rear surface of the print head.

Meanwhile, in the step d), the cleaning operation may be performed as a cleaning arm is moved along the rear surface of the print head.

Further, in the step d), an absorption member may absorb the remaining ink in contact with the rear surface of the print head. The absorption member may also perform the cleaning operation while moving along the rear surface of the print head.

It should be understood that in the above description, the ‘rear surface’ of the print head includes all of the side surfaces of the print head. That is, in a rectangular print head, for example, a lower side can be a nozzle surface, while four side surfaces can be the rear surface, respectively.

According to embodiments of the present invention, while the rear surface of the print head is cleaned, the nozzle portion of the print head is prevented from being contaminated by the ink which remains after the cleaning.

### BRIEF DESCRIPTION OF THE DRAWINGS

The above aspects and other features of the present invention will become more apparent in connection with the following detailed description of a preferred embodiment thereof with reference to the attached drawing figures, in which:

FIG. 1A is a view illustrating a conventional maintenance method of an inkjet printer;

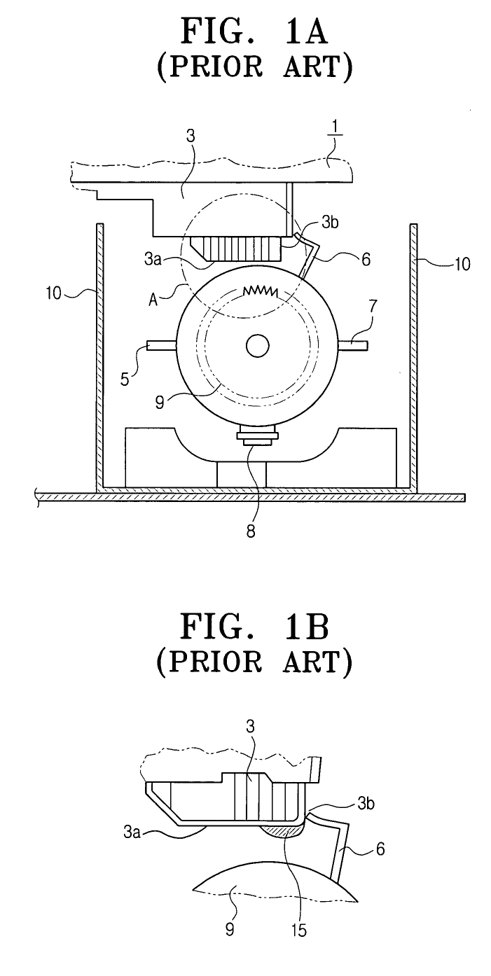

FIG. 1B is a view illustrating a more detailed view of the circle ‘A’ of FIG. 1A;

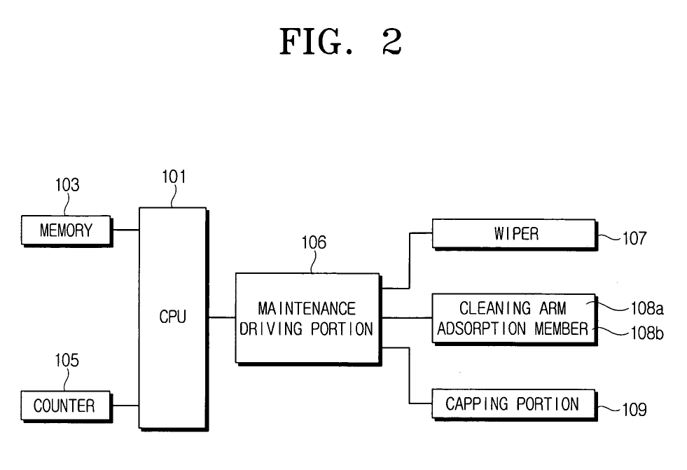

FIG. 2 is a block diagram of a system for achieving a maintenance method according to one embodiment of the present invention;

FIGS. 3A and 3B are flowcharts for illustrating a maintenance method according to an embodiment of the present invention; and

FIGS. 4A to 4C are views for illustrating the maintenance method as shown in FIGS. 3A and 3B.

Thoughout the figures it should be understood that like reference numerals refer to like features and structures.

### DETAILED DESCRIPTION OF THE PREFERRED EMBODIMENTS

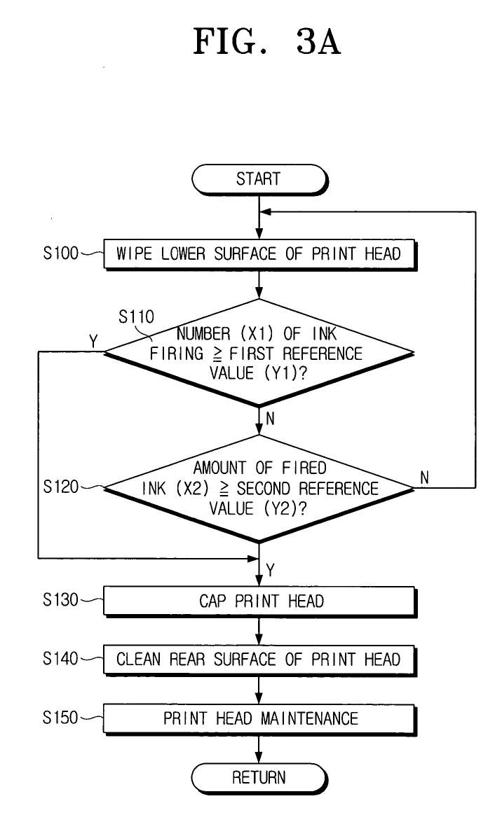

Referring to FIG. 2A, a system for achieving the maintenance method according to an embodiment of the present invention includes a central processing unit (CPU) 101 for controlling the overall system, a memory 103 for storing first through third reference values, which will be described later, and also a program for controlling the overall system. The system further includes a counter 105 for counting the number (X1) of ink firings, the amount (X2) of discharged ink and the number (X3) of wipings. The system further includes a wiper 107 for wiping the nozzle surface 3a of the print head 3, a cleaning arm 108a or an adsorption member 108b for cleaning the rear surface 3b of the print head 3, and a capping portion 109 for capping the print head 3.

Hereinbelow, the maintenance method for an inkjet printer according to one preferred embodiment of the present invention will be described.

Generally, the maintenance in an inkjet printer refers to the process in which the ink discharged through the nozzles of the print head 3 are prevented from contaminating the nozzle surface 3a, and the carriage 1 is moved to the service region provided at one side of the printer system, the nozzle surface 3a is wiped, and the nozzle surface 3a is capped to prevent the contact with external air.

The wiping and capping are performed with respect to the nozzle surface 3a of the print head 3 after completion of the printing, and if the printing is not completed, the carriage 1 is moved back to the printing region after the maintenance process. The number (X1) of ink firings through the nozzles of the print head 3, and the amount (X2) of the fired ink during the printing, are counted through the counter 105.

In maintenance, the nozzle surface 3a of the print head 3 is wiped by a wiper 109 (S100). Next, the number (X1) of ink firings, which is counted by the counter 105, is compared by the CPU 101 with the first reference value Y1 stored in the memory 103 (S110).

The first reference value Y1 refers to an average value which is obtained by an experiment on the number of ink firings when the rear surface 3b of the print head 3 is contaminated by the remaining ink.

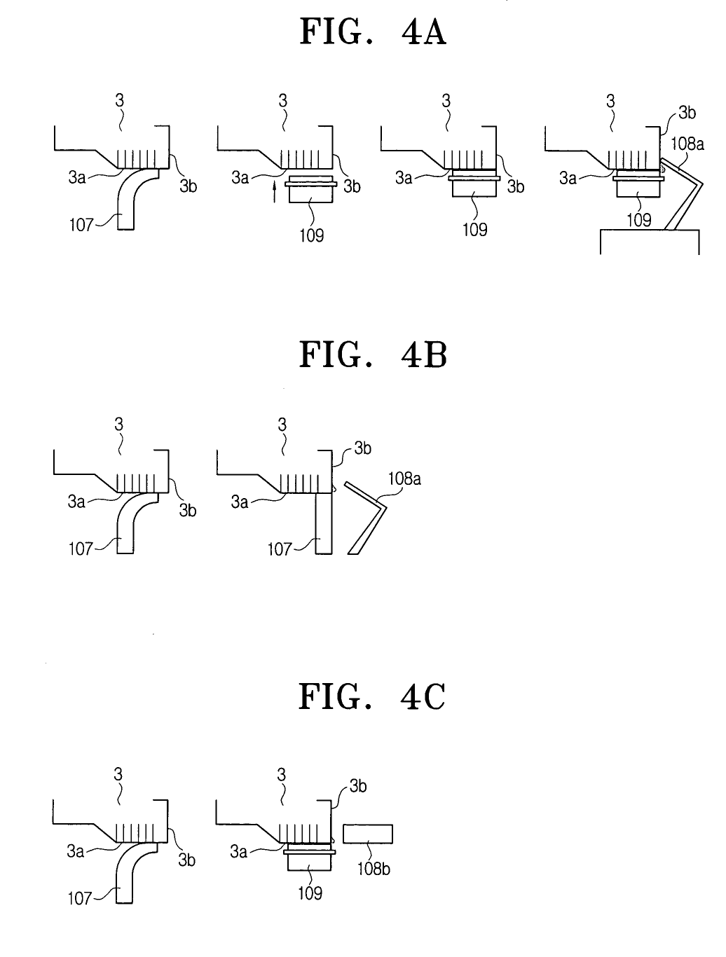

If it is determined that X1≧Y1 in S110, that is, when the number of ink firings is equal to or greater than the first reference value, the CPU 101 gives the maintenance driving portion 106 a command to block the nozzle surface 3a of the print head 3. In the preferred embodiment of the present invention, the nozzle surface 3a is blocked by capping. That is, the CPU 101 causes the maintenance driving portion 106 to lift the capping portion 109 to a position as shown in FIG. 4A to cap the nozzle surface 3a.

Meanwhile, if it is determined that X1<Y1 in S110, there is no cleaning of rear surface 3b of the print head 3, but only a regular maintenance is performed. The regular maintenance refers to a process in which, during printing, the wiping is performed and the carriage is moved back to the printing region to resume printing operation. Upon completion of printing, the wiping and then the capping is performed.

Even when the number (X1) of ink firings is smaller than the first reference value (Y1), if the amount of fired ink abruptly increases such as for ‘black printing,’ the rear surface 3b is again exposed to the possibility of being contaminated by the remaining ink 15. Accordingly, it is preferable to set a second reference value (Y2) through an experiment on the regular amount of fired ink and store the reference value (Y2) in the memory 103.

The amount (X2) of fired ink is counted through the counter 105 during the printing, and the CPU 101 compares the counted amount (X2) with the second reference value (Y2) (S120). If it is determined that X2≧Y2 in S120, such as in the case of ‘black printing’ which has abrupt increase of fired ink, the nozzle surface 3a of the print head 3 is capped (S130).

Meanwhile, if it is determined that X2<Y2, a regular maintenance is performed.

Next, with the nozzle surface 3a of the print head 3 being capped, that is, with the nozzle surface 3a and the rear surface 3b of the print head 3 being blocked, the rear surface 3b of the print head 3 is cleaned (S140).

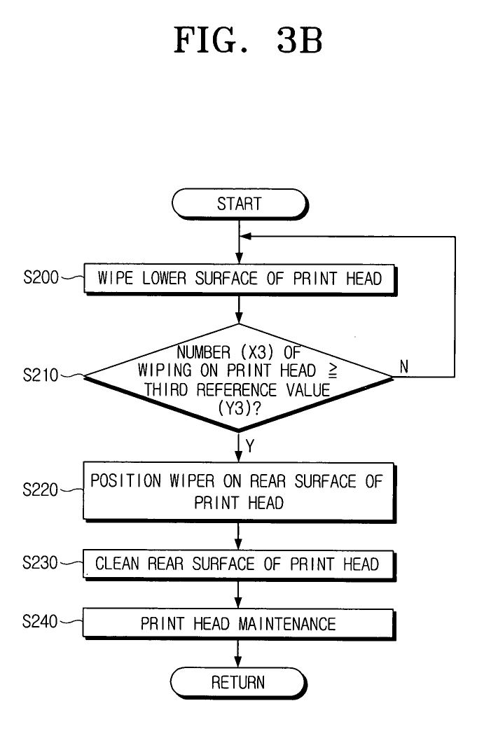

Meanwhile, according to another preferred embodiment of the present invention, with reference to FIG. 3B, the number (X3) of wipings on the print head 3 during the regular maintenance process is counted through the counter 105. The counted number (X3) of wipings is compared with a third reference value (Y3) which is pre-stored in the memory 103 (S210). If it is determined that X3≧Y3 in S210, the nozzle surface 3a of the print head 3 is blocked (S220). The third reference value (Y3) is obtained through an experiment on the number of wipings when the rear surface 3b of the print head 3 is contaminated.

Meanwhile, according to yet another preferred embodiment of the present invention, the nozzle surface 3a of the print head 3 is blocked as the wiper 107 is positioned in line with the rear surface 3b of the print head 3 (S220).

Accordingly, while being blocked from the nozzle surface 3a, the rear surface 3b is cleaned by the cleaning arm 108a (FIG. 4A) (S140, S230). That is, the cleaning arm 108a is moved along the rear surface 3b side of the print head 3, removing the remaining ink 15 by the frictional force. Because the nozzle surface 3a and the rear surface 3b are blocked from each other, re-contamination of nozzle surface 3a by the ink can be prevented when the rear surface 3b of the print head 3 is cleaned.

Meanwhile, the rear surface 3b of the print head 3 can also be cleaned by a separate absorption member 108b as shown in FIG. 4C. That is, while the rear surface 3b is blocked from the nozzle surface 3a, the absorption member 108b performs the cleaning on the rear surface 3b by absorbing the remaining ink. The absorption member 108b can be constructed so as to move along the rear surface 3b of the print head 3 together with the cleaning arm 108a.

After completing the cleaning of the print head 3 (S150), the capping state is maintained if the printing operation is to be ended, while the carriage is moved back to the printing region to assume the printing job if the printing operation is to be continued.

Although a few preferred embodiments of the present invention has been described, it will be understood by those skilled in the art that the present invention should not be limited to the described preferred embodiments, but various changes and modifications can be made within the spirit and scope of the present invention as defined by the appended claims.

1. A maintenance method for an inkjet printer comprising:
wiping a nozzle surface of a print head with a wiper,
blocking the nozzle surface from outside, and
cleaning the print head excluding the blocked nozzle surface.

2. The maintenance method of claim 1, wherein the blocking step comprises capping the nozzle surface.

3. The maintenance method of claim 1, wherein the step of cleaning the print head excluding the blocked nozzle surface comprises cleaning with an absorption member adapted to absorb remaining ink.

4. The maintenance method of claim 3, wherein the absorption member performs the cleaning operation while moving along the print head excluding the blocked nozzle surface.

5. The maintenance method of claim 1, wherein the step of cleaning the print head excluding the blocked nozzle surface comprises cleaning the print head with a cleaning arm which is moved along the print head excluding the blocked nozzle surface.

6. The maintenance method of claim 1, wherein the nozzle surface of the print head is blocked as the wiper is positioned in line with a side of the print head.

7. The maintenance method of claim 6, wherein the step of cleaning the print head excluding the blocked nozzle surface comprises cleaning the print head with an absorption member adapted to absorb remaining ink.

8. The maintenance method of claim 7, wherein the absorption member performs the cleaning operation while moving along the print head excluding the blocked nozzle surface.

9. The maintenance method of claim 6, wherein the step of cleaning the print head excluding the blocked nozzle surface comprises t cleaning the print head with a cleaning arm adapted to move along the print head excluding the blocked nozzle surface.

10. A maintenance method for an inkjet printer, comprising the steps of:
a) wiping a nozzle surface of a print head with a wiper;
b) calculating a number (X1) of ink droplet firings and comparing the calculated number (X1) with a first reference value (Y1);
c) if X1≧Y1 in step b), blocking the nozzle surface of the print head; and
d) cleaning the print head, with the nozzle surface being blocked.

11. The maintenance method of claim 10, wherein step c) comprises capping the print head.

12. The maintenance method of claim 11, wherein, in step d), the cleaning operation is performed as the cleaning arm is moved along the print head.

13. The maintenance method of claim 11, wherein in step d), remaining ink is absorbed by an absorption member adapted to contact the print head.

14. The maintenance method of claim 13, wherein the absorption member is adapted to absorb the remaining ink while moving along the print head.

15. The maintenance method of claim 10, wherein, in step c), the wiper is positioned in line with a side of the print head.

16. The maintenance method of claim 15, wherein, in step d), the cleaning operation is performed as a cleaning arm is moved along the print head.

17. The maintenance method of claim 15, wherein, in step d), the remaining ink is absorbed by an absorption member adapted to contact the print head.

18. The maintenance method of claim 17, wherein the absorption member is adapted to absorb the remaining ink while moving along the print head.

19. The maintenance method of claim 10, wherein step b) further comprises the step of calculating an amount of fired ink droplets and comparing the calculated amount (X3) with a third reference value (Y3), and
if X1<Y1 and if X3≧Y3, step c) further comprises the step of blocking a nozzle surface of the print head.

20. The maintenance method of claim 19, wherein step c) comprises capping the print head.

21. The maintenance method of claim 20, wherein, in step d), the cleaning is performed as a cleaning arm is moved along the print head.

22. The maintenance method of claim 20, wherein in step d), remaining ink is absorbed by an absorption member adapted to contact the print head.

23. The maintenance method of claim 22, wherein the absorption member is adapted to absorbs remaining ink while moving along the print head.

24. The maintenance method of claim 19, wherein in step c), the wiper is positioned in line with a side of the print head.

25. The maintenance method of claim 24, wherein in step d), the cleaning operation is performed as a cleaning arm is moved along the print head.

26. The maintenance method of claim 24, wherein in step d), remaining ink is absorbed by an absorption member which is adapted to contact the print head.

27. The maintenance method of claim 26, wherein the absorption member absorbs the remaining ink while moving along the print head.

28. A maintenance method for an inkjet printer, comprising the steps of:
a) wiping a nozzle surface of a print head with a wiper;
b) calculating a number (X2) of wipings on the print head and comparing the calculated number (X2) with a second reference value (Y2);
c) if X2≧Y2 in step b), blocking the nozzle surface of the print head; and
d) cleaning the print head, with the nozzle surface being blocked.

29. The maintenance method of claim 28, wherein step c) comprises capping the print head.

30. The maintenance method of claim 29, wherein, in step d), the cleaning operation is performed as a cleaning arm is moved along the print head.

31. The maintenance method of claim 29, wherein, in step d), remaining ink is absorbed by an absorption member adapted to contact the print head.

32. The maintenance method of claim 31, wherein the absorption member is adapted to absorb remaining ink while being moved along the print head.

33. The maintenance method of claim 28, wherein in step c), the wiper is positioned in line with a side of the print head.

34. The maintenance method of claim 33, wherein, in step d), the cleaning operation is performed as a cleaning arm is moved along the print head.

35. The maintenance method of claim 33, wherein, in step d), the remaining ink is absorbed by an absorption member adapted to contact the print head.

36. The maintenance method of claim 35, wherein the absorption member absorbs remaining ink while being moved along the print head.
